(19) United States
(12) Patent Application Publication
(10) Pub. No.: US 2023/0307688 A1
(43) Pub. Date: Sep. 28, 2023

(54) Apparatus and Method for Manufacturing Unit Cell

(71) Applicant: LG Energy Solution, Ltd., Seoul (KR)

(72) Inventors: Dong Hyeuk Park, Daejeon (KR); Ji Woon Lee, Daejeon (KR); Joo Hyung Kim, Daejeon (KR); Sung Jun Jo, Daejeon (KR)

(73) Assignee: LG Energy Solution, Ltd., Seoul (KR)

(21) Appl. No.: 18/123,709

(22) Filed: Mar. 20, 2023

(30) Foreign Application Priority Data
Mar. 22, 2022 (KR) 10-2022-0035628

(51) Int. Cl. H01M 10/04

(52) U.S. Cl. CPC H01M 10/0404

(57) ABSTRACT

An apparatus for manufacturing a unit cell may include a first separator unwinder from which a first separator sheet is unwound, a first magazine in which a plurality of first electrodes are loaded, a first transfer part which picks up the first electrodes from the first magazine and seats the first electrodes on the first separator sheet, and a second separator unwinder from which a second separator sheet is unwound so as to cover the first electrodes. The apparatus may further include a vision sensor which detects the locations of the first electrodes, a second magazine in which a plurality of second electrodes are loaded, and a second transfer part which picks up the second electrodes from the second magazine and seats the second electrodes on the second separator sheet so as to correspond to the locations of the first electrodes, respectively.

### CROSS-REFERENCE TO RELATED APPLICATIONS

This application claims priority from Korean Patent Application No. 10-2022-0035628 filed on Mar. 22, 2022, the disclosures of which are incorporated herein by reference.

### BACKGROUND OF THE INVENTION

### Field of the Invention

The present disclosure relates to an apparatus and method for manufacturing a unit cell, and more particularly, to an apparatus and method for manufacturing a unit cell formed by stacking an electrode and a separator sheet.

### Description of the Related Art

In general, types of secondary batteries include nickel-cadmium batteries, nickel-hydrogen batteries, lithium-ion batteries, a lithium-ion polymer batteries, and so on. Such secondary batteries are applied to and used in not only small products such as digital camera, P-DVD, MP3P, mobile phone, PDA, portable game device, power tool, and E-bike, but also large products, such as electric vehicle and hybrid vehicle, which require high output, energy storage systems for storing surplus electricity or new renewable energy, and energy storage systems for backup.

In order to manufacture such secondary batteries, a positive electrode collector and a negative electrode collector are coated with electrode active material slurry to make a positive electrode and a negative electrode, and then the positive electrode and the negative electrode are stacked at both sides of a separator to form an electrode assembly having a predetermined shape. Thereafter, a battery case accommodates the electrode assembly and is sealed after injection of an electrolyte.

The electrode assembly may be classified into various types. Examples thereof include a simple stack type electrode assembly manufactured by simply stacking a positive electrode, a separator, and a negative electrode repeatedly in this order without manufacturing a unit cell, a lamination & stack (L&S) type electrode assembly manufactured by using positive electrodes, separators, and negative electrodes to manufacture unit cells and then stacking these unit cells, a stack & folding (S&F) type electrode assembly manufactured by attaching a plurality of electrodes or unit cells to one surface of a separator sheet having a length extending in one direction so as to be spaced apart from each other and repeatedly folding the separator sheet from one end in the same direction, a Z-folding type electrode assembly manufactured by alternately attaching a plurality of electrodes or unit cells to one surface and the other surface of a separator sheet having a length extending in one direction and repeatedly folding the separator sheet in such a manner that the separator sheet is folded from one end in a specific direction and then folded in the opposite direction, and so on.

In order to manufacture the L&S type, S&F type, or Z-folding type electrode assembly among the foregoing types, a unit cell may be manufactured first. According to the related art, in order to manufacture the unit cell, a separator sheet is stacked on each of top and bottom surfaces of a center electrode and then an upper electrode is further stacked at the uppermost end, while the center electrode is transferred through a conveyor belt or the like, in one direction. A lower electrode may be further stacked at the lowest end in some cases. Then, a laminating process of applying heat and pressure to a stack, in which the electrode and the separator sheet are stacked, may be performed, and the separator sheet may be cut to manufacture the unit cell.

Such a method according to the related art (e.g., KR 2021-0055186 A), however, requires a process in which an electrode sheet wound in a roll shape is continuously supplied and such an electrode sheet is cut at fixed intervals to form unit electrodes.

In this case, various limitations may occur as follows.

First, as the overall length of equipment increases, a space required for installation of the equipment may become excessively large. As the electrode sheet is very sensitive because of its material properties, there is a concern that a fracture of the electrode sheet during traveling may cause losses. There is also a concern that electrode debris may occur because of delamination during cutting of the electrode sheet. As the electrode sheet in a roll shape needs to be replaced at regular intervals, there is a concern that a defect may occur at a connection portion between the previously used electrode sheet and a new electrode sheet. Moreover, there is a concern that meandering of the electrode sheet may cause a defect.

### SUMMARY OF THE INVENTION

An aspect of the present invention provides an apparatus and method for manufacturing a unit cell, which are capable of solving the foregoing limitations that may be caused by continuous supply of an electrode sheet.

Another aspect of the present invention provides an apparatus and method for manufacturing a unit cell, which precisely adjust alignment between a first electrode and a second electrode to improve quality of the unit cell.

According to an aspect of the present invention, there is provided an apparatus for manufacturing a unit cell, the apparatus including a first separator unwinder from which a first separator sheet is unwound, a first magazine in which a plurality of first electrodes are loaded, a first transfer part which picks up the first electrodes of the first magazine and seats the first electrodes on the first separator sheet, a second separator unwinder from which a second separator sheet is unwound so as to cover the first electrodes seated on the first separator sheet, a vision sensor which projects the second separator sheet and detects the first electrodes, a second magazine in which a plurality of second electrodes are loaded, a second transfer part which picks up the second electrodes of the second magazine and seats the second electrodes on the second separator sheet so as to correspond to the first electrodes, respectively, on the basis of a detection result of the vision sensor.

The apparatus for manufacturing a unit cell may further include a sub-vision sensor that detects the first electrodes seated on the first separator sheet by the first transfer part.

The apparatus for manufacturing a unit cell may further a bonding roller that bonds the first electrodes to the first separator sheet before the first electrodes are covered by the second separator sheet.

The bonding roller may rotate in a state heated to a preset temperature and apply heat and pressure to a stack of the first electrodes and the first separator sheet.

The apparatus for manufacturing a unit cell may further include a film unwinder, which unwinds a protective film so as to pass between the stack of the first electrodes and the first separator sheet and the bonding roller, and a film rewinder which winds the protective film passing between the stack and the bonding roller.

Each of the first magazine and the second magazine may be provided in plurality. The first transfer part may simultaneously pick up the plurality of first electrodes from the plurality of first magazines and seat the plurality of first electrodes on the first separator sheet. The second transfer part may simultaneously pick up the plurality of second electrodes from the plurality of second magazines and seat the plurality of second electrodes on the second separator sheet.

The apparatus for manufacturing a unit cell may further include a rolling device that rolls a stack in which the first separator sheet, the first electrodes, the second separator sheet, and the second electrodes are stacked.

The apparatus for manufacturing a unit cell may further include a film unwinder, which unwinds a protective film so as to pass between the stack and the rolling device, and a film rewinder which winds the protective film passing between the stack and the rolling device.

The apparatus for manufacturing a unit cell may further include a cutter that is disposed behind the rolling device in a traveling direction of the stack and cuts the stack to form the unit cell.

According to another aspect of the present invention, there is provided a method for manufacturing a unit cell, the method including unwinding a first separator sheet, picking up a first electrode loaded in a first magazine and seating the first electrode on the first separator sheet, unwinding a second separator sheet so as to cover the first electrode seated on the first separator sheet, projecting the second separator sheet to detect the first electrode by a vision sensor, and picking up a second electrode loaded in a second magazine and seating the second electrode on the second separator sheet so as to correspond to the first electrode on the basis of a detection result of the vision sensor.

The method for manufacturing a unit cell may further include bonding the first electrode to the first separator sheet by a bonding roller before the first electrode is covered by the second separator sheet.

The bonding roller may bond the first electrode to the first separator sheet with the protective film therebetween.

The method for manufacturing a unit cell may further include rolling, by a rolling device, a stack in which the first separator sheet, the first electrode, the second separator sheet, and the second electrode are stacked.

The rolling device may roll the stack with the protective film therebetween.

### BRIEF DESCRIPTION OF THE DRAWINGS

The following drawings attached in this specification illustrate embodiments of the present invention and function to make further understood the technical spirit of the present invention along with the detailed description of embodiments of the invention. The present invention should not be construed as being limited to only the drawings. In the drawings:

FIG. 1 is a flowchart of a method for manufacturing a unit cell according to an embodiment of the present invention;

FIG. 2 is a schematic view of an apparatus for manufacturing a unit cell according to an embodiment of the present invention;

FIG. 3 is a schematic side view of an apparatus for manufacturing a unit cell according to an embodiment of the present invention; and

FIG. 4 is a schematic view of an apparatus for manufacturing a unit cell according to another embodiment of the present invention.

### DETAILED DESCRIPTION

Hereinafter, embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure the subject matter of the present invention, are omitted in order to clearly convey the present invention. Like reference numerals refer to like elements throughout the whole specification.

Moreover, terms or words used in this specification and claims should not be restrictively interpreted as ordinary meanings or dictionary-based meanings, but should be interpreted as having meanings and concepts conforming to the scope of the present invention on the basis of the principle that an inventor can properly define the concept of a term to describe and explain his or her invention in the best way.

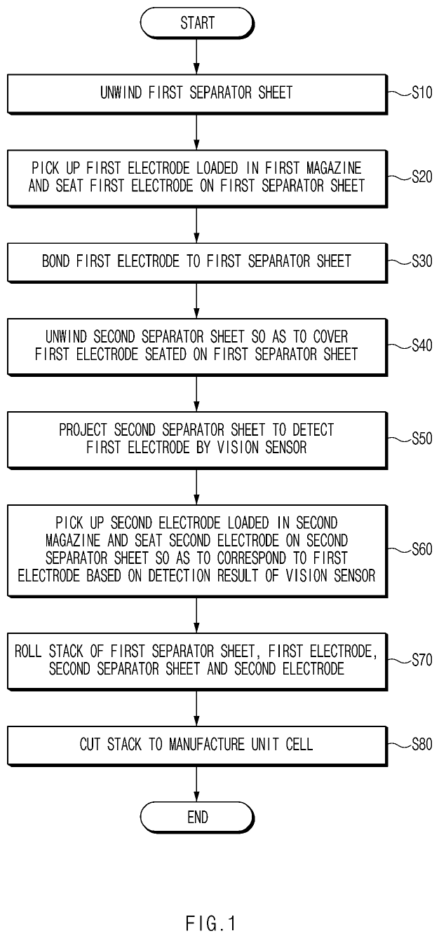

FIG. 1 is a flowchart of a method for manufacturing a unit cell according to an embodiment of the present invention.

A method for manufacturing a unit cell according to an embodiment of the present invention (hereinafter referred to as the “manufacture method”) includes unwinding a first separator sheet 1 (S10), picking up a first electrode 2 loaded in a first magazine 120 and seating the first electrode 2 on the first separator sheet 1 (S20), unwinding a second separator sheet 3 so as to cover the first electrode 2 seated on the first separator sheet 1 (S40), projecting the second separator sheet 3 to detect the first electrode 2 by a vision sensor 210 (S50), and picking up a second electrode 4 loaded a second magazine 150 and seating the second electrode 4 on the second separator sheet so as to correspond to the first electrode 2 on the basis of a detection result of the vision sensor 210 (S60).

The manufacture method may further include bonding the first electrode 2 to the first separator sheet 1 by a bonding roller 310 before the first electrode 2 is covered by the second separator sheet 3 (S30).

The manufacture method may further include rolling a stack 20 in which the first separator sheet 1, the first electrode 2, the second separator sheet 3, and the second electrode 4 are stacked (S70). The manufacture method may further include cutting the stack 20 to manufacture a unit cell 30 (S80).

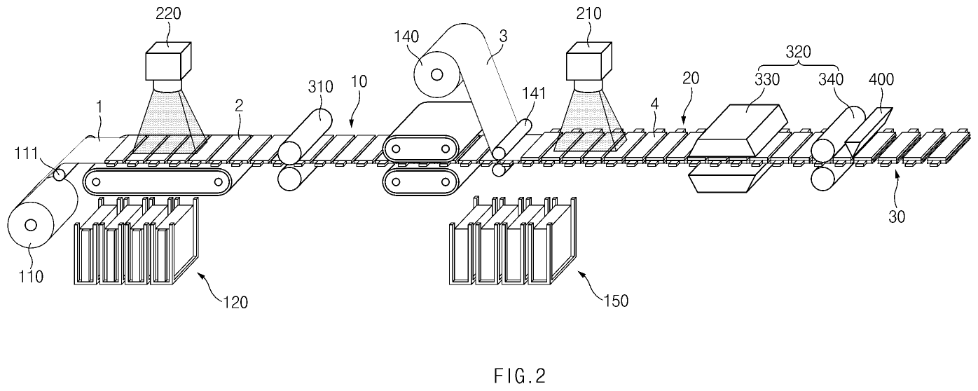

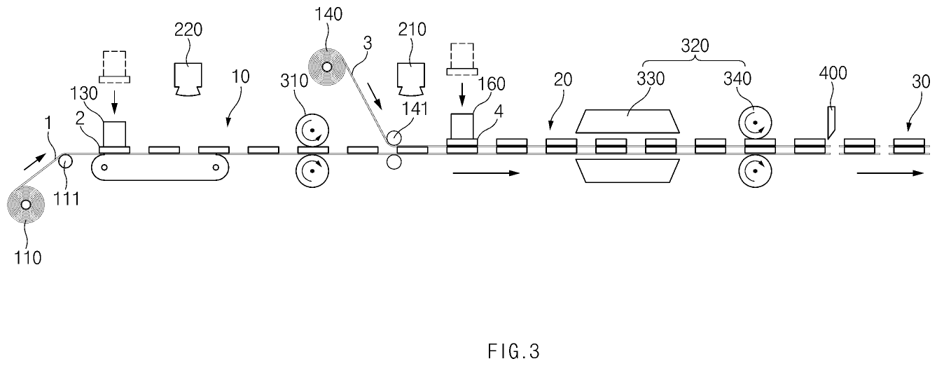

FIG. 2 is a schematic view of an apparatus for manufacturing a unit cell according to an embodiment of the present invention. FIG. 3 is a schematic side view of an apparatus for manufacturing a unit cell according to an embodiment of the present invention.

Hereinafter, the processes shown in the flowchart in FIG. 1 will be specifically described with reference to FIGS. 2 and 3.

An apparatus for manufacturing a unit cell according to an embodiment of the present invention (hereinafter referred to as the “manufacture apparatus”) includes a first separator unwinder 110, a first magazine 120, a first transfer part 130, a second separator unwinder 140, a vision sensor 210, a second magazine 150, and a second transfer part 160.

The first separator unwinder 110 may unwind a first separator sheet 1. That is, the unwinding of the first separator sheet 1 (S10) may be performed by the first separator unwinder 110. The first separator unwinder 110 may be a reel on which the first separator sheet 1 is wound in a roll shape.

The first separator sheet 1 may be unwound obliquely from the first separator unwinder 110, and a traveling direction of the first separator sheet 1 may be changed into a horizontal direction by at least one first separator guide roller 111.

A plurality of first electrodes 2 may be loaded in the first magazine 120. For example, each of the first electrodes 2 may be a negative electrode. The first electrode 2 loaded in the first magazine 120 may be a unit electrode in a state in which a non-coating portion is notched in the form of an electrode tab.

The first transfer part 130 may pick up the first electrode 2 of the first magazine 120 and seat the first electrode 2 on the first separator sheet 1. That is, the picking up of the first electrode 2 loaded in the first magazine 120 and seating the first electrode 2 on the first separator sheet 1 (S20) may be performed by the first transfer part 130.

The first electrodes 2 may be seated at fixed intervals in the traveling direction of the first separator sheet 1. The first electrodes 2 may be stacked on the first separator sheet 1 to constitute a stack 10.

The first transfer part 130 may pick up the first electrode 2 loaded in the first magazine 120 and move to an upper side of the first separator sheet 1 to seat the first electrode 2 on the first separator sheet 1. The first transfer part 130 may be configured to be movable horizontally and vertically.

The first transfer part 130 may be a pick and place (P&P) apparatus. For example, the first transfer part 130 may include a header that picks up the first electrode 2, and a mover that moves the header horizontally and vertically. The configuration of the first transfer part 130 is not limited and may change as necessary.

The first magazine 120 may be provided in plurality. For example, four first magazine 120 may be provided as illustrated in FIG. 2. The first transfer part 130 may simultaneously pick up the plurality of first electrodes 2 from the plurality of first magazines 120 and seat the first electrodes 2 on the first separator sheet 1. Accordingly, the first electrodes 2 may be rapidly seated at the fixed intervals on the first separator sheet 1 while maintaining a high traveling speed of the first separator sheet 1. The number of the first magazines 120 may be determined as appropriate according to the traveling speed of the first separator sheet 1.

The second separator unwinder 140 may unwind a second separator sheet 3 so as to cover the first electrode 2 seated on the first separator sheet 1. That is, the unwinding of the second separator sheet 3 so as to cover the first electrode 2 seated on the first separator sheet 1 (S40) may be performed by the second separator unwinder 140. The second separator unwinder 140 may be a reel on which the second separator sheet 3 is wound in a roll shape.

The second separator sheet 3 may be unwound obliquely from the second separator unwinder 140, and a traveling direction of the second separator sheet 3 may be changed into a horizontal direction by at least one second separator guide roller 141.

The vision sensor 210 may project the second separator sheet 3 to detect the first electrode 2. That is, the projecting of the second separator sheet 3 to detect the first electrode 2 (S50) may be performed by the vision sensor 210.

The vision sensor 210 may be disposed behind the second separator unwinder 140 in the traveling direction of the second separator sheet 3. The vision sensor 120 may be disposed to face a top surface of the second separator sheet 3. The vision sensor 210 may be disposed in front of a rolling device 320 to be described later, in the traveling direction of the second separator sheet 3.

The vision sensor 210 may photograph a specific region and receive an image signal for the specific region to obtain an image. For example, the vision sensor 210 may include an imaging device such as a charge coupled device (CCD) or a complementary metal-oxide semiconductor (CMOS).

As is well known to those skilled in the art, a separator sheet may have a transparent or translucent material. Therefore, the vision sensor 210 can easily detect the first electrode 2 through the second separator sheet 3.

A plurality of second electrodes 4 may be loaded in the second magazine 150. Each of the second electrodes 4 may have a polarity opposite to that of the first electrode 2 described above. For example, the second electrode 4 may be a positive electrode. The second electrode 4 loaded in the second magazine 150 may be a unit electrode in a state in which a non-coating portion is notched in the form of an electrode tab.

The second transfer part 160 may pick up the second electrode 4 of the second magazine 150 and seat the second electrode 4 on the second separator sheet 2. In more detail, the second transfer part 160 may pick up the second electrode 4 of the second magazine 150 and seat the second electrode 4 on the second separator sheet 3 so as to correspond to the first electrode 2 on the basis of the detection result of the vision sensor 210. That is, the picking up of the second electrode 4 loaded in the second magazine 150 and seating the second electrode 4 on the second separator sheet 3 so as to correspond to the first electrodes 2 (S60) may be performed by the second transfer part 160.

The second electrodes 4 may be seated at fixed intervals in the traveling direction of the second separator sheet 3. The second electrodes 4 may be seated to face the first electrodes 2, respectively, with the second separator sheet 3 therebetween. Thus, the first separator sheet 1, the first electrode 2, the second separator sheet 3, and the second electrode 4 may be stacked in sequence from a lower side and constitute a stack 20.

For convenience of explanation, the stack 10 in which the first separator sheet 1 and the first electrode 2 are stacked may be referred to as a first stack, and the stack 20 in which the first separator sheet 1, the first electrode 2, the second separator sheet 3, and the second electrode 4 are stacked may be referred to as a second stack. That is, the second stack 20 may be formed by additionally stacking the second separator sheet 3 and the second electrode 4 on the first stack 10.

The second transfer part 160 may pick up the second electrode 4 loaded in the second magazine 150 and move to an upper side of the second separator sheet 3 to seat the second electrode 4 on the second separator sheet 3. The second transfer part 160 may be configured to be movable horizontally and vertically.

The second transfer part 160 may be a pick and place (P&P) apparatus. For example, the second transfer part 160 may include a header that picks up the second electrode 4, and a mover that moves the header horizontally and vertically. The configuration of the second transfer part 160 is not limited and may change as necessary.

The second magazine 150 may be provided in plurality. For example, four second magazine 150 may be provided as illustrated in FIG. 2. The second transfer part 160 may simultaneously pick up the plurality of second electrodes 4 from the plurality of second magazines 150 and seat the second electrodes 4 on the second separator sheet 3. Accordingly, the second electrodes 4 may be rapidly seated at the fixed intervals on the second separator sheet 3 while maintaining a high traveling speed of the first separator sheet 1, the first electrode 2, and the second separator sheet 3. The number of the second magazines 120 may be determined as appropriate according to the traveling speed of the first separator sheet 1, the first electrode 2, and the second separator sheet 3.

The vision sensor 210 described above may detect a position of the second electrode 4 seated on the second separator sheet 3.

In more detail, the imaging area of the vision sensor 210 may include a first area and a second area. The first area may be a region before the second electrode 4 is seated on the second separator sheet 3. The second area may be a region after the second electrode 4 is seated on the second separator sheet 3. The vision sensor 210 may detect a position of the first electrode 4 through the second separator sheet 3 in the first area. The vision sensor 210 may detect a position of the second electrode 4 in the second area.

However, embodiments of the present invention are not limited thereto, and it may be possible to provide another vision sensor (not shown) for detecting a position of the second electrode 4.

Although not illustrated in the drawings, the manufacture apparatus may further include a processor (not shown) capable of determining the position of the second electrode 4 on the basis of image information obtained from the vision sensor 210. The processor may repeatedly store and correct position data of the second electrode 4 through deep learning and increase the precision of the position at which the second electrode 4 is seated on the second separator sheet 3.

For example, the processor may repeatedly store a plurality of position data of the second electrode 4 to learn a normal position. The processor may update the normal position as position data of the second electrode 4 is added. If deviation between a new position data of second electrode 4 and the normal position exceeds a predetermined range, the new position data may be determined to be abnormal and not reflected in the normal position. These operations of the processor may be performed by an automated mechanism.

The manufacture apparatus may further include a sub-vision sensor 220.

The sub-vision sensor 220 may detect the first electrode 2 on the first separator sheet 1 by the first transfer part 130.

In more detail, the sub-vision sensor 220 may detect a position of the first electrode 2 seated on the first separator sheet 1. Although not illustrated in the drawings, the manufacture apparatus may further include a processor (not shown) capable of determining the position of the first electrode 2 on the basis of image information obtained from the sub-vision sensor 220. The processor may repeatedly store and correct position data of the first electrode 2 through deep learning and increase the precision of the position at which the first electrode 2 is seated on the first separator sheet 1.

The sub-vision sensor 220 may be disposed behind the first separator unwinder 110 in the traveling direction of the first separator sheet 1. The sub-vision sensor 220 may be disposed to face a top surface of the first separator sheet 1. The sub-vision sensor 220 may be disposed in front of a bonding roller 310 to be described later, in the traveling direction of the first separator sheet 1.

Like the vision sensor 210, the sub-vision sensor 220 may photograph a specific region and receive an image signal for the specific region to obtain an image. For example, the sub-vision sensor 220 may include an imaging device such as a charge coupled device (CCD) or a complementary metal-oxide semiconductor (CMOS).

The manufacture apparatus may further include the bonding roller 310.

The bonding roller 310 may bond the first electrode 2 to the first separator sheet 1 before the first electrode 2 is covered by the second separator sheet 3. That is, the bonding of the first electrode 2 to the first separator sheet 1 (S30) may be performed by the bonding roller 310.

The bonding roller 310 may be disposed behind the first separator unwinder 110, the sub-vision sensor 220, and the first transfer part 130. The bonding roller 310 may be disposed in front of the second separator unwinder 140.

The bonding roller 310 may be provided in a pair which are disposed to face each other vertically and between which the stack 10, in which the first separator sheet 1 and the first electrode 2 are stacked, is interposed. The stack 10 may be pressed by passing between the pair of the bonding roller 310, and the first electrode 2 may be bonded to the first separator sheet 1.

The bonding roller 310 may rotate in a state heated to a preset temperature and apply heat and pressure to the stack 10. The preset temperature may mean a temperature that is far higher than room temperature. The bonding roller 310 may be a heating roller. Accordingly, the first electrode 2 may be reliably bonded to the first separator sheet.

The bonding between the first electrode 2 and the first separator sheet 1 by the bonding roller 310 may be temporary bonding having rather low bonding force. In more detail, the bonding force between the first electrode 2 and the first separator sheet 1 passing through the bonding roller 310 may be lower than bonding force the first electrode 2 and the first separator sheet 1 passing through the rolling device 320 to be described later.

The first electrode 2 may be fixed to the first separator sheet 1 by the bonding roller 310, thereby preventing displacement of the first electrode 2.

The manufacture apparatus may further include the rolling device 320.

The rolling device 320 may roll the stack 20 in which the first separator sheet 1, the first electrode 2, the second separator sheet 3, and the second electrode 4 are stacked. The rolling of the stack 20 in which the first separator sheet 1, the first electrode 2, the second separator sheet 3, and the second electrode 4 are stacked (S70) may be performed by the rolling device 320.

The rolling device 320 may be disposed behind the second separator unwinder 140, the vision sensor 210, and the second transfer part 160. The rolling device 320 may be disposed in front of a cutter 400 to be described later.

In more detail, the rolling device 320 may include a heater 330 that applies heat to the stack 20, and a pressing roller 340 that applies pressure to the stack 20.

The heater 330 may be provided in a pair disposed to face each other vertically with the stack 20 therebetween. Thus, the heater 330 may apply the heat to each of both surfaces of the stack 20.

Alternatively, the heater 330 may be configured to be elevatable vertically and apply the pressure to the stack 20. In this case, the heater 330 may have one approximately flat surface, which faces the stack 20. Accordingly, the heat and the pressure may be uniformly applied to the stack 20.

The pressing roller 340 may be disposed behind the heater 330 in a traveling direction of the stack 20. The pressing roller 340 may be provided in a pair disposed to face each other vertically with the stack 20 therebetween. Thus, the stack 20 heated by the heater 330 may be pressed while passing between the pair of the pressing roller 340, and the first separator sheet 1, the first electrode 2, the second separator sheet 3, and the second electrode 4 may be rolled together with one another.

The pressing roller 340 may rotate in a state heated to a preset temperature and apply heat and pressure to the stack 20. The preset temperature may mean a temperature that is far higher than room temperature. That is, pressing roller 340 may be a heating roller.

In general, the pressing roller 340, which applies pressure while rotating, applies greater pressure than the heater 330 that applies pressure simply with a flat surface. Thus, as the heater 330 applies the heat and the pressure to the stack 20 and then the pressing roller 340 applies greater heat and pressure to the stack 20 than the heater 330, the heat and pressure applied to the stack 20 may gradually increase. That is, the stack 20 may be more strongly laminated while preventing the stack 20 from being internally damaged by rapid changes in temperature and pressure.

However, embodiments of the present invention are not limited thereto, and the rolling device 320 may include only one among the heater 330 and the pressing roller 340.

The manufacture apparatus may further include the cutter 400.

The cutter 400 may be disposed behind the rolling device 320 in a traveling direction of the stack 20, and cut the stack 20 to form the unit cell 30. That is, the cutting of the stack 20 to manufacture the unit cell 30 (S80) may be performed by the cutter 400.

In more detail, the cutter 400 may cut the first separator sheet 1 and the second separator sheet 3 of the stack 20. Accordingly, the unit cell 30, in which the cut first separator sheet 1, the first electrode 2, the cut second separator sheet 3, and the second electrode 4 are stacked in sequence from a lower side, may be formed.

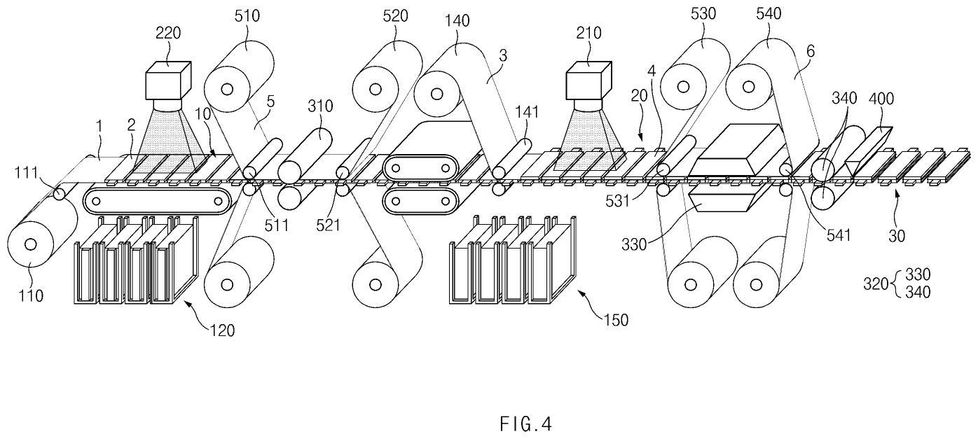

FIG. 4 is a schematic view of an apparatus for manufacturing a unit cell according to another embodiment of the present invention.

Hereinafter, the content in common with the content described above will apply and the description will be focused on differences.

Referring to FIG. 4, an apparatus for manufacturing a unit cell according to another embodiment of the present invention (hereinafter referred to as the “manufacture apparatus”) may further include a first film unwinder 510 and a first film rewinder 520.

The first film unwinder 510 may unwind a first protective film 5 so as to pass between a first stack 10 and a bonding roller 310, and the first film rewinder 520 may wind the first protective film 5 passing between the first stack 10 and the bonding roller 310.

For example, the first protective film 5 may have a polyethylene terephthalate (PET) material.

The first film unwinder 510 and the first film rewinder 520 may be disposed at both sides, respectively, of a bonding roller 310 in a traveling direction of the first stack 10.

The first protective film 5 may be unwound obliquely from the first film unwinder 510, and may pass between the first stack 10 and the bonding roller 310 as a traveling direction thereof is changed into a horizontal direction by at least one film guide roller 511. The first protective film 5 passing between the first stack 10 and the bonding roller 310 may be wound on the first film rewinder 520 as the traveling direction thereof is changed into an inclined direction by at least one film guide roller 521.

In more detail, each of the first film unwinder 510 and the first film rewinder 520 may be provided in a pair. The pair of first film unwinders 510 may be disposed in opposite directions with the first stack 10 therebetween, and the pair of first film rewinders 520 may also be disposed in opposite directions with the first stack 10 therebetween. The first protective film 5 unwound from the first film unwinder 510 at an upper side may pass between the bonding roller 310 and a first separator sheet 1 at the upper side, and may be wound on the first film rewinder 520 at the upper side. The first protective film 5 unwound from the first film unwinder 510 at a lower side may pass between the bonding roller 310 and a first electrode 2 at the lower side, and may be wound on the first film rewinder 520 at the lower side.

Accordingly, the bonding roller 310 may bond the first electrode 2 to the first separator sheet 1 with the first protective film 5 therebetween. The first protective film 5 may prevent the first stack 10 from be damaged by heat and pressure applied to the first stack 10.

The manufacture apparatus may further include a second film unwinder 530 and a second film rewinder 540.

The second film unwinder 530 may unwind a second protective film 6 so as to pass between a second stack 20 and a rolling device 320, and the second film rewinder 540 may wind the second protective film 6 passing between the second stack 20 and the rolling device 320.

For example, the second protective film 6 may have a polyethylene terephthalate (PET) material.

The second protective film 6 may be configured to pass between the rolling device 320 and the second stack 20.

In one example, as illustrated in FIG. 4, the second protective film 6 may be configured to pass between a heater 330 of the rolling device 320 and the second stack 20. In this case, the second film unwinder 530 and the second film rewinder 540 be disposed at both sides, respectively, of the heater 330 in a traveling direction of the second stack 20.

In another example, the second protective film 6 may be configured to pass between a pressing roller 340 and the second stack 20. In this case, the second film unwinder 530 and the second film rewinder 540 be disposed at both sides, respectively, of the pressing roller 340 in the traveling direction of the second stack 20.

In further another example, the second protective film 6 may be configured to sequentially pass between the heater 330 and the second stack 20 and between the pressing roller 340 and the second stack 20. In this case, the second film unwinder 530 and the second film rewinder 540 may be disposed at both sides, respectively, of the heater 330 and pressing roller 340 in the traveling direction of the second stack 20.

The second protective film 6 may be unwound obliquely from the second film unwinder 530, and may pass between the second stack 20 and the rolling device 320 as a traveling direction thereof is changed into a horizontal direction by at least one film guide roller 531. The second protective film 6 passing between the second stack 20 and the rolling device 320 may be wound on the second film rewinder 540 as the traveling direction thereof is changed into an inclined direction by at least one film guide roller 541.

In more detail, each of the second film unwinder 530 and the second film rewinder 540 may be provided in a pair. The pair of second film unwinder 530 may be disposed in opposite directions with the second stack 20 therebetween, and the pair of second film rewinder 540 may also be disposed in opposite directions with the second stack 20 therebetween. The second protective film 6 unwound from the second film unwinder 530 at the upper side may pass between the rolling device 320 and a second electrode 4 at the upper side, and may be wound on the second film rewinder 540 at the upper side. The second protective film 6 unwound from the second film unwinder 530 at the lower side may pass between the rolling device 320 and a first separator sheet 1 at the lower side, and may be wound on the second film rewinder 540 at the lower side.

Accordingly, the rolling device 320 may roll the second stack 20 between the second protective film 6 therebetween. The second protective film 6 may prevent the second stack 20 from be damaged by heat and pressure applied to the second stack 20.

Alternatively, the manufacture apparatus may include only one among a first film device, which includes the first film unwinder 510 and the first film rewinder 520, and a second film device which includes the second film unwinder 530 and the second film rewinder 540.

According to some embodiments of the present invention, the second electrode is seated on the second separator sheet so as to correspond to the first electrode on the basis of the detection result of the vision sensor that projects the second separator sheet to detect the first electrode. Accordingly, the alignment between the first electrode and the second electrode may be precisely adjusted to improve the quality of the unit cell.

As the first electrode and the second electrode, which are previously cut unit electrodes, are supplied discontinuously, not continuously, the process such as the cutting of the electrode sheet, may not be included to reduce the length of the equipment, and the occurrence of the losses, the delamination, the connection defects, the meandering, or the like, which may occur during the traveling and cutting of the electrode sheet, may be fundamentally blocked.

In addition, the effects may be included which could be easily predicted by those skilled in the art from the configurations according to the embodiments of the present invention.

The description of the present invention is intended to be illustrative, and various changes and modifications can be made by those of ordinary skill in the art to which the present invention pertains, without departing from the spirit and scope of the present invention as defined by the appended claims.

Therefore, the embodiments set forth herein are intended to describe the technical spirit of the present invention and not to limit. The scope of the technical spirit of the present invention is not limited by the embodiments.

Moreover, the protective scope of the present invention should be determined by reasonable interpretation of the appended claims and all technical concepts coming within the equivalency range of the present application should be interpreted to be in the scope of the right of the present application.

What is claimed is:

1. An apparatus for manufacturing a unit cell, the apparatus comprising:
a first separator unwinder from which a first separator sheet is configured to be unwound;
a first magazine configured to receive a plurality of first electrodes;
a first transfer part configured to repeatedly retrieve the first electrodes from the first magazine and seat the first electrodes on the first separator sheet;
a second separator unwinder from which a second separator sheet is configured to be unwound so as to cover the first electrodes seated on the first separator sheet;
a vision sensor configured to detect the locations of the first electrodes through the second separator sheet;
a second magazine configured to receive a plurality of second electrodes; and
a second transfer part configured to repeatedly retrieve the second electrodes from the second magazine and seat the second electrodes on the second separator sheet so as to correspond to the locations of the first electrodes detected by the vision sensor, respectively.

2. The apparatus of claim 1, further comprising a sub-vision sensor configured to detect the first electrodes seated on the first separator sheet by the first transfer part.

3. The apparatus of claim 1, further comprising a bonding roller configured to bond the first electrodes to the first separator sheet before the first electrodes are covered by the second separator sheet.

4. The apparatus of claim 3, wherein the bonding roller is configured to rotate in a heated state and apply heat and pressure to a stack comprising a combination of the first electrodes seated on the first separator sheet.

5. The apparatus of claim 3, further comprising:
a film unwinder configured to unwind a protective film so as to pass between the stack and the bonding roller; and
a film rewinder configured to rewind the protective film.

6. The apparatus of claim 1, wherein each of the first magazine and the second magazine is provided in plurality,
wherein the first transfer part simultaneously picks up the plurality of first electrodes from the plurality of first magazines and seats the plurality of first electrodes on the first separator sheet, and
the second transfer part simultaneously picks up the plurality of second electrodes from the plurality of second magazines and seats the plurality of second electrodes on the second separator sheet.

7. The apparatus of claim 1, further comprising a rolling device configured to roll a stack comprising a combination of the first separator sheet, the first electrodes, the second separator sheet, and the second electrodes stacked atop one another.

8. The apparatus of claim 7, further comprising:
a film unwinder configured to unwind a protective film so as to pass between the stack and the rolling device; and
a film rewinder configured to rewind the protective film.

9. The apparatus of claim 7, further comprising a cutter disposed after the rolling device along a traveling direction of the stack and configured to cut the stack to form the unit cell.

10. A method for manufacturing a unit cell, the method comprising:
unwinding a first separator sheet;
picking up a first electrode loaded in a first magazine and seating the first electrode on the first separator sheet;
unwinding a second separator sheet so as to cover the first electrode seated on the first separator sheet;
detecting the location of the first electrode through the second separator sheet by a vision sensor; and
picking up a second electrode loaded in a second magazine and seating the second electrode on the second separator sheet so as to correspond to the location of the first electrode detected by the vision sensor.

11. The method of claim 10, further comprising bonding the first electrode to the first separator sheet by a bonding roller before the first electrode is covered by the second separator sheet.

12. The method of claim 11, wherein the bonding roller bonds the first electrode to the first separator sheet with a protective film therebetween.

13. The method of claim 10, further comprising rolling, by a rolling device, a stack comprising a combination of the first separator sheet, the first electrode, the second separator sheet, and the second electrode stacked atop one another.

14. The method of claim 13, wherein the rolling device rolls the stack with a protective film therebetween.
